(19) United States
(12) Patent Application Publication
(10) Pub. No.: US 2025/0285166 A1
(43) Pub. Date: Sep. 11, 2025

(54) SYSTEMS AND METHODS FOR MANAGING PICKUP ORDERS

(71) Applicant: Radius Networks, Inc., Washington, DC (US)

(72) Inventors: Maie Lee, Washington, DC (US); Keith Yoder, Washington, DC (US); Lily Larsen, Washington, DC (US); Marc Wallace, Arlington, VA (US); Timothy Judkins, Vienna, VA (US); David Helms, Arlington, CA (US); James Nebeker, Catonsville, MD (US); Scott Newman, Aurora, CO (US); Christopher Sexton, McLean, VA (US)

(73) Assignee: Radius Networks, Inc., Washington, DC (US)

(21) Appl. No.: 19/075,125

(22) Filed: Mar. 10, 2025

Related U.S. Application Data
(60) Provisional application No. 63/563,769, filed on Mar. 11, 2024.
(60) Provisional application No. 63/573,759, filed on Apr. 3, 2024.

(51) Int. Cl. G06Q 30/0601

(52) U.S. Cl. CPC G06Q 30/0635

(57) ABSTRACT

Techniques for managing pickup orders are discussed herein. A managing computing device can receive first and second pickup orders made at different time points associated with a first user. The pickup orders can be directed to the same store. The managing computing device can group the first and the second pickup orders as a batched order which can update a priority of the first or second pickup order. The managing computing device can receive location data from a computing device associated with the first user or a third party. The managing computing device can determine an estimated arrival time of the first user or the third party based on the location data. The managing computing device can send a message to a store computing device associated with the store, indicating the estimated arrival time and the batched order associated with the first user.

### CROSS REFERENCE TO RELATED PATENT APPLICATIONS

This application is a continuation application claiming benefit of U.S. Provisional Application No. 63/573,759, titled “SYSTEMS AND METHODS FOR MANAGING PICKUP ORDERS,” filed Apr. 3, 2024, and to U.S. Provisional Application No. 63/563,769, titled “SYSTEMS AND METHODS FOR MACHINE-LEARNING OPTIMIZATION FOR ESTIMATED TIME OF ARRIVAL ANALYSIS AND/OR CAPACITY DETERMINATION,” field, Mar. 11, 2024, both of which are hereby incorporated by reference in their entirety.

### BACKGROUND

Ease of the purchase and order fulfillment experience, for any product or service, is a key contributor to consumer decisions to purchase from one particular business over another. The rise of online shopping is a good example where ease of use is leading to an increase of use, as consumers decide to forego traffic, parking hassles, and other problems with brick and mortar retailers by ordering from the comfort of their home. Competing with online merchants has proven a significant challenge for brick-and-mortar retailers, even those with a web presence. It takes less time and expense to order from home than to travel to a store, look for parking, pay for parking, walk to the store, peruse as they would on-line, wait in payment line, then do it all again in reverse order to return home. The parking hassles in particular pose a great challenge to brick and mortar retailers, especially in urban areas where parking stalls may be increasingly sparse and expensive.

However, visiting locations associated with traditional brick and mortar retailers, such as storefronts, warehouses, service centers, and/or the like, may remain preferable for consumers with time-relevant needs, as picking up an item from a nearby retail location may still be faster than waiting for a delivery to arrive. Likewise, for perishable goods such as food take-out, or for personal goods such as dry-cleaning, visiting a brick-and-mortar retailer may remain the most practical option. For prepared food or simple errands, take-out/pickup may be an increasingly popular option, especially when it can be done as part of an efficient travel stream in a string of errands.

In some instances, a customer may make a first pickup order at first, and add a second pickup order later. A conventional order managing system may list the orders in a queue based on the order time. Between the first and the second pickup orders made by the same customer, there may be several other orders made by other people in the queue. If a vendor (such as a restaurant, a retailer, a grocery store, or the like) prepares the orders according to the queue, the first pickup order and the second pickup order may be prepared separately. Sometimes, when the customer or a pickup entity arrives at the vendor's place, the first order can be ready, but the second order is still unprepared. Thus, the customer or the pickup entity has to wait at the vendor's place until the second order is ready. In that case, the waiting time of the customer or the pickup entity can be unnecessarily long, and the customer experience can be dissatisfied.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some examples, systems and methods for managing pickup orders are provided. A managing computing device can receive first and a second pickup orders made at different time points associated with a first user. The first and the second pickup orders can be directed to the same store. The managing computing device can group the first and the second pickup orders as a first batched order. The managing computing device can receive first location data from a first computing device associated with the first user or a third party. The managing computing device can determine a first estimated arrival time of the first user or the third party based on the first location data. The managing computing device can send a first message to a store computing device associated with the store, indicating the first estimated arrival time (EAT) and the first batched order associated with the first user. In some examples, the third party may include a pickup service provider, a deliverer, or a non-human entity.

In some examples, the managing computing device can generate an order queue. The order queue can list multiple orders based on estimated arrival time (e.g., of a pickup entity). The managing computing device can send the order queue to a store computing device associated with the store. An individual order (or a batched order) in the order queue can be associated with a priority. In some examples, the priority can be determined on various factors, such as EAT, a starting time, a preparation time, or the like.

Methods and systems for managing pickup orders discussed herein can improve the function of a computing device by determining orders associated with the same user, and grouping these orders together so that staff of the store can prepare/package the batched order together, saving time and resources, improving processing efficiency. Benefits of grouping pickup orders associated with the same user/deliverer together can include increased revenue due to streamlined operations, faster handoff, and improved order throughput/processing.

### DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 illustrates an example environment including a store, a first user, a second user, managing computing device(s) in accordance with examples of the disclosure.

FIG. 2 illustrates an example environment that is usable to implement the techniques and systems described herein.

FIGS. 3A, 3B, and 3C illustrate an example process for managing pickup orders in accordance with examples of the disclosure.

FIGS. 4A and 4B illustrate an example graphical user interface (GUI) that can be displayed via a display component on a store computing device in accordance with examples of the disclosure.

FIG. 5 illustrates an example GUI that can be displayed on a display of a user device in accordance with examples of the disclosure.

### DETAILED DESCRIPTION

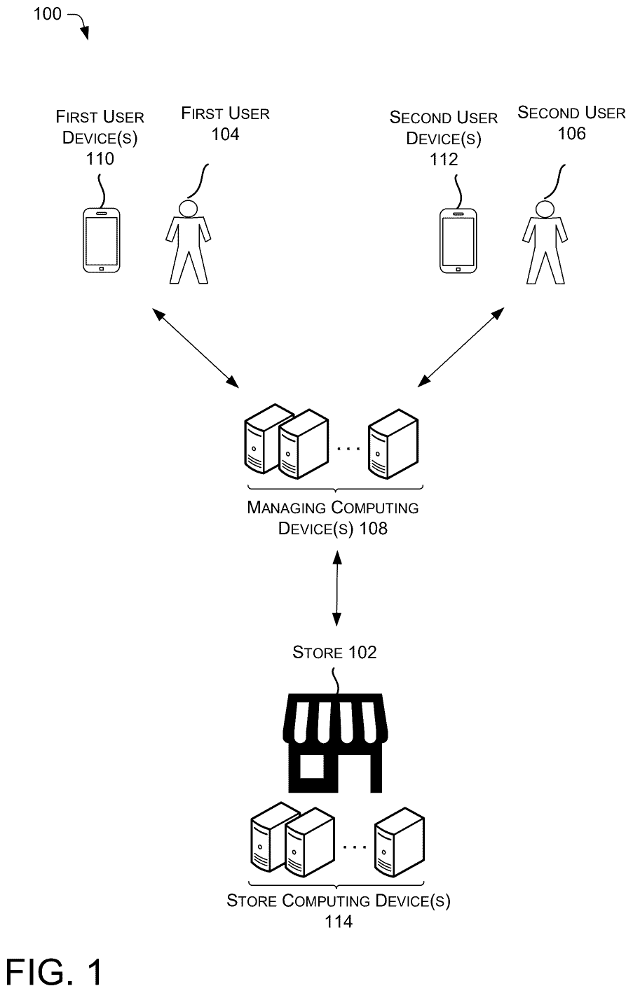

FIG. 1 illustrates an example environment 100 including a store 102, a first user 104, a second user 106, and managing computing device(s) 108 in accordance with examples of the disclosure. As described herein, the store 102 may be, but is not limited to, a restaurant, a supermarket, a grocery store, a retailer, a cosmetic store, a shopping mall, a department store, a pharmacy, a vehicle rental center, a dry-cleaning shop, and so on.

The first user 104 may be associated with one or more first user device(s) 110. The second user may be associated with one or more second user device(s) 112. In some examples, the first user device(s) 110 and the second user device(s) 112 can be used to make pickup orders, collect location data, and communicate with other devices. In some instances, the first user device(s) 110 and the second user device(s) 112 can include, but are not limited to, a smartphone, a mobile phone, a personal digital assistant (PDA), a laptop computer, a desktop computer, a point of sale (POS) system, a tablet computer, a portable computer, a server computer, a wearable device (e.g., smart watches, smart glasses, or the like), or the like. In some instances, the first user and the second user can be the customers who make orders directed to the store 102. Additionally or alternatively, the first user and the second user can be a third party. For example, the third party can be a pickup entity that provides pick-up services, such as delivery drivers, delivery bikers, non-human entities (e.g., drones, delivery vehicles, or the like), or the like.

The store 102 may be associated with one or more store computing device(s) 114. In some examples, the store 102 may communicate with the managing computing device(s) 108 via the store computing device(s) 114. It should be understood that there may be more than one store included in the environment 100.

The managing computing device(s) 108 can communicate with the first user device(s) 110 and/or the second user device(s) 112. In some examples, the first user 104 can make the order and pick up the order by him/herself. Additionally or alternatively, the order can be made by the customer while the order can be picked up by a pickup entity that provides pick up and delivery services. In some examples, the managing computing device(s) 108 may receive orders (e.g., food pickup orders, grocery pickup orders, pharmacy pickup orders, or the like) from the first user device(s) 110 and/or the second user device(s) 112.

The managing computing device(s) 108 may receive first location data from the first user device(s) 110 and second location data from the second user device(s) 112. The managing computing device(s) 108 can determine a first location of the first user device(s) 110 based on the first location data, and a second location of the second user device(s) 112 based on the second location data. In some examples, the location data may include, but is not limited to, latitude data, a longitude data, Global Positioning System (GPS) data, accuracy data, speed data, map data, or the like associated with the first user device(s) 110 and/or the second user device(s) 112. In some examples, the location data can be updated in a predetermined period of time, in real-time, in near real-time, etc.

The managing computing device(s) 108 can determine a first estimated arrival time of the first user device(s) 110 based on the first location data, and a second estimated arrival time of the second user device(s) 112 based on the second location data. In some instances, the managing computing device(s) 108 can determine a preparation time for an individual order. In some examples, the managing computing device(s) 108 can determine a starting time for preparing the order based on the estimated arrival time and/or a preparation time for the order. Additional details are given throughout this disclosure. Further, examples of estimating an arrival time are provided in U.S. application Ser. No. 18/497,486, filed Oct. 20, 2023, and U.S. Provisional Application Ser. No. 63/563,769, filed Mar. 11, 2024. applications Ser. No. 18/497,486 and 63/563,769 are hereby incorporated by reference herein in their entirety and for all purposes.

The managing computing device(s) 108 can maintain an order queue in which orders associated with various users are listed. In some instances, the orders can be listed based on priorities associated with the orders. In some instances, the managing computing device(s) 108 can insert a new order into the order queue based on a priority associated with the new order upon receiving the new order. In some instances, the managing computing device(s) 108 can insert an order into the order queue based on an estimated arrival time (e.g., of the pickup entity, such as a customer or delivery driver or delivery service provider) associated with the order. In some instances, the managing computing device(s) 108 can group multiple orders associated with the same user to be a batched order, and/or prioritize the batched order based on an estimated arrival time associated with the user. Additional details are given throughout this disclosure.

The managing computing device(s) 108 may send data/messages to the store 102, the first user device(s) 110, and the second user device(s) 112. For example, the managing computing device(s) 108 may data/messages to the store 102, indicating the first estimated arrival time of the first user 104 and/or the second estimated arrival time of the second user 106. In some examples, the managing computing device(s) 108 may send data/messages to the first user device(s) 110, indicating the status of the order. Additional details are given throughout this disclosure.

The techniques described herein may improve the functioning of a computing device by providing a robust method of managing orders. The techniques discussed herein (e.g., batching of orders) can reduce signaling and can simplify and streamline database management. Combining orders can reduce processing overhead to manage individual timers, alerts, and notifications. Further, consolidating orders can simplify coordination with other entities, which can reduce network signaling and downstream processing, and can improve customer experience and real-world traffic management. These and other improvements to the functioning of the computer are discussed herein.

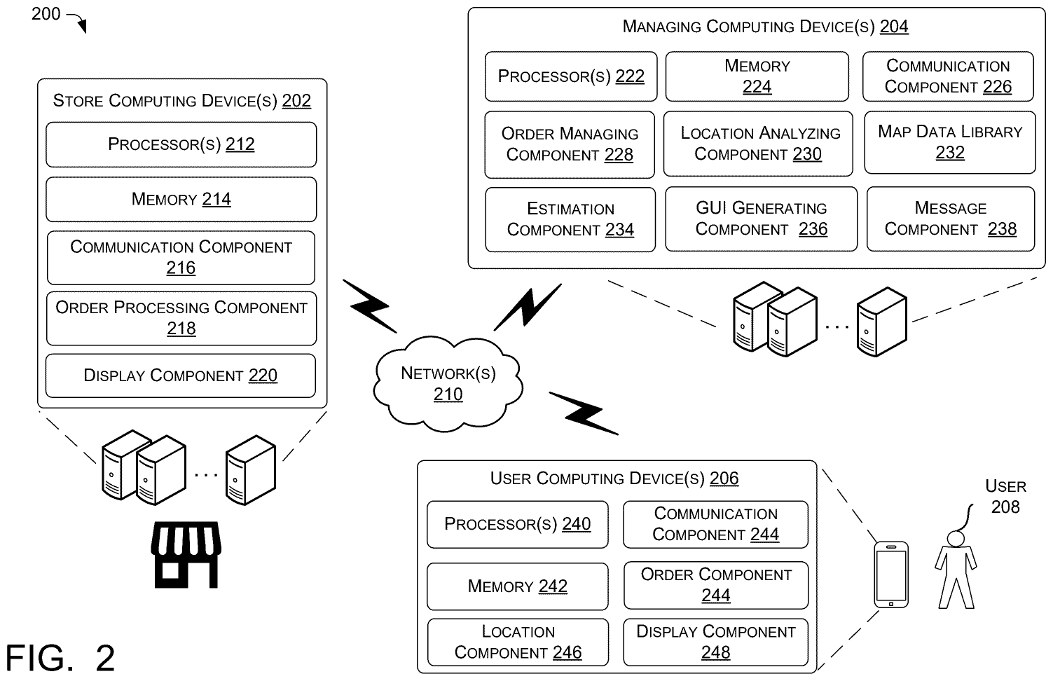

FIG. 2 illustrates an example environment 200 that is usable to implement the techniques and systems described herein. The environment 200 can include store computing device(s) 202 associated with a store, managing computing device(s) 204, user computing device(s) 206 associated with a user 208. In some examples, the user 208 can make the order and pick up the order by herself. Additionally or alternatively, the order can be made by the user 208 while the order can be picked up by the pickup entity that provides pickup and delivery services (e.g., a delivery service provider). In various examples, the store computing device(s) 202, the managing computing device(s) 204, and the user computing device(s) 206 can communicate wired or wirelessly via one or more networks 210.

The store computing device(s) 202 can include a variety of devices, including portable devices or stationary devices. For instance, the store computing device(s) 202 can include a smart phone, a mobile phone, a personal digital assistant (PDA), a laptop computer, a desktop computer, a point of sale (POS) system, a tablet computer, a portable computer, a server computer, a wearable device (e.g., smart watches, smart glasses, or the like), or any other electronic devices. In various examples, the store computing device(s) 202 can correspond to the store computing device(s) 114 in FIG. 1.

The store computing device(s) 202 can include one or more processor(s) 212 and memory 214. The processor(s) 212 can be a single processing unit or a number of units, each of which could include multiple different processing units. The processor(s) 212 can include a microprocessor, a microcomputer, a microcontroller, a digital signal processor, a central processing unit (CPU), a graphics processing unit (GPU), a security processor, etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), pulse counters, resistor/coil readers, other logic circuitry, a system on chip (SoC), and/or any other devices that perform operations based on instructions. Among other capabilities, the processor(s) 212 can be configured to fetch and execute computer-readable instructions stored in the memory 214.

The memory 214 can include one or a combination of computer-readable media. As used herein, “computer-readable media” includes computer storage media and communication media. Computer storage media includes volatile and non-volatile, removable, and non-removable media implemented in any method or technology for the storage of information, such as computer-readable instructions, data structures, program modules, or other data. Computer storage media includes, but is not limited to, Phase Change Memory (PRAM), Static Random-Access Memory (SRAM), Dynamic Random-Access Memory (DRAM), other types of Random-Access Memory (RAM), Read Only Memory (ROM), Electrically Erasable Programmable ROM (EEPROM), flash memory or other memory technology, Compact Disc ROM (CD-ROM), Digital Versatile Discs (DVD) or other optical storage, magnetic cassettes, magnetic tape, magnetic disk storage or other magnetic storage devices, or any other medium that can be used to store information for access by a computing device. In contrast, communication media includes computer-readable instructions, data structures, program modules, or other data in a modulated data signal, such as a carrier wave. As defined herein, computer storage media (e.g., one or more non-transitory computer-readable media) does not include communication media. In some examples, one or more non-transitory computer-readable media does not include communication media.

The memory 214 can include an operating system configured to manage hardware and services within and coupled to a device for the benefit of other modules, components, and devices. In some examples, the store computing device(s) 202 can include one or more servers or other computing devices that operate within a network service (e.g., a cloud service), or can form a mesh network, etc.

The store computing device(s) 202 can also include a communication component 216 to communicate with another computing device(s) (e.g., in mesh network) and/or to communicate via the network(s) 210. In some instances, the communication component 216 can perform compression, encryption/decryption, and/or formatting of the data. In some examples, the communication component 216 can transmit data using one or more protocols or languages, such as an extensible markup language (XML), Modbus, HTTP, HTTPS, USB, etc. In some examples, store computing device(s) 202 can receive various data from the managing computing device(s) 204 via the communication component 216, such as the order data, the user data, the location data, data regarding the estimated arrival time (EAT) (also referred to as an estimated time of arrival), the preparation time, the starting time, or the like. In some examples, the store computing device(s) 202 can receive notifications, messages, alerts, or the like from the managing computing device(s) 204 via the communication component 216 through the network(s) 210.

The store computing device(s) 202 can also include an order processing component 218. In some examples, the order processing component 218 can process orders based on order data. In some instances, the order processing component 218 can keep, maintain, or otherwise determine an order queue. Additionally or alternatively, the orders can be prepared based on the order queue. The order processing component 218 can sort orders in the order queue based on the priority associated with an individual the order. As such, orders with higher priorities can be listed in higher positions in the order queue (and will be made/prepared earlier), while orders with lower priorities can be listed in lower positions in the order queue (and will be made/prepared later). Alternatively, orders can be listed in a reversed order in the order queue. In some instances, multiple orders made by the same customer can be batched to form a batched order. The batched order can be associated with a priority, and can be inserted into the order queue based on the associated priority.

In some examples, the priority of the order (or a batched order) can be determined based on the estimated arrival time (e.g., of the pickup entity), the preparation time for the order, etc. For example, the order processing component 218 can determine the priority of the order (or a batched order) based on a First-Arrived-First-Out (FAFO) rule. That is, an order (or a batched order) associated with a user who has a relatively earlier estimated arrival time will be prioritized over another order (or another batched order) associated with another user who has a relatively later estimated arrival time. Also, an order (or a batched order) associated with a user who has already arrived at the store can be prioritized over another order (or another batched order) associated with another user who has not yet arrived at the store. For example, a first user has a first estimated arrival time of 9:30 am, while a second user has a second estimated arrival time of 9:45 am. Then, the order processing component 218 can prioritize the first order (or a first batched order) associated with the first user over the second order (or a second batched order) associated with the second user (e.g., regardless of when the orders were received at the stored computing device(s) 202). As such, the first order (or the first batched order) associated with the first user can have a higher priority (be in a higher position in the order queue), while the second order (or the second batched order) associated with the second user can have a lower priority (be in a lower position in the order queue).

As can be understood, although the disclosure often describes the techniques in connection with a first order and a second order, any number of orders is contemplated and the aspects are not limited to two, three, or any number of orders.

Additionally or alternatively, the order processing component 218 can determine the priority of the order (or the batched order) based on the preparation time for the order (or the batched order). An order (or a batched order) with a relatively shorter preparation time can be in a lower position in the order queue, and an order with a longer preparation time can be in a higher position in the order queue. For example, a first order (or a first batched order) associated with a first user has a first preparation time for 2 minutes, while a second order (or a second batched order) associated with a second user has a second preparation time for 4 minutes. Then, the order processing component 218 can prioritize the second order (or the second batched order) over the first order (or the first batched order).

In some examples, the order processing component 218 can determine a starting time of an order based on the EAT and the preparation time for the order (or the batched order). The order processing component 218 can determine the priority of the order (or the batched order) based on the starting time. For example, a first order (or a first batched order) has a first estimated arrival time of 9:30 am and takes 2 minutes to prepare. The starting time for the first order (or the first batched order) can be 9:28 am. As another example, a second order (or a second batched order) has a second estimated arrival time of 9:35 am and takes 10 minutes to prepare. The starting time for the second order (or the second batched order) can be 9:25 am. Thus, the second starting time is earlier than the first starting time. Then, the order processing component 218 can update the order queue based on the first starting time and the second starting time. In other words, the order processing component 218 can prioritize the second order (or a second batched order) associated with a second user over the first order (or the first batched order) associated with the first user.

In some examples, the order processing component 218 can insert a new order (or a new batched order) in the order queue upon receiving the new order (or the new batched order) based on a priority associated with the new order (or the batched order) and the priorities of other orders already in the order queue. In some examples, the priority of the order (or the batched order) can be represented by numbers (e.g., 1, 2, 3, or the like), letters (e.g., A, B, C, or the like), symbols (e.g., *, **, ***, or the like), words (e.g., low, high medium, or the like), colors (e.g., red, green, yellow, or the like), or the like.

The store computing device(s) 202 can include a display component 220 configured to display information to a person (e.g., an employee, a manager, a cook, a contractor, or the like) or a machine (e.g., a robotic order preparation device) in the store. In some examples, the store computing device(s) 202 can receive GUI data from the managing computing device(s) 204 and display a GUI based on the GUI data. Additionally or alternatively, the store computing device(s) 202 can generate a GUI based on data (e.g., the order data, the location data, the user data, or the like) received from the managing computing device(s) 204.

The managing computing device(s) 204 can include one or more processor(s) 222, a memory 224, and a communication component 226, each of which can be implemented similarly to the processor(s) 212, the memory 214, and/or the communication component 216 of the store computing device(s) 202.

In some examples, the managing computing device(s) 204 can include one or components such as an order managing component 228, a location analyzing component 230, a map data library 232, an estimation component 234, a graphical user interface (GUI) generating component 236, and/or a message component 238. Note that such components are exemplary rather than limiting, and some of them can be omitted or replaced by other components. Additional components can be added to the managing computing device(s) 204.

The managing computing device(s) 204 can receive order data and/or user data from the user computing device(s) 206, and can store the order data in the memory 224 of the order managing component 228. In some examples, the order data may indicate services and/or items ordered by the user (e.g., food items, drink items, prescription drugs, grocery items, or the like). In some examples, the order managing component 228 can store the timestamp data (which may indicate the time the order was made) associated with the order data input from the user computing device(s) 206. In some examples, the order data and/or the user data can further include an order identifier (e.g., an order ID) and/or a transaction identifier (e.g., a transaction ID).

In some examples, the managing computing device(s) 204 can be referred to as a third-party computing device, a computing device, and the like. In some examples, the computing device 204 can be associated with a delivery service provider that receives orders from a user and dispatches pickup entities to the store, but is otherwise unassociated with the store. That is, in some examples, the computing device(s) 204 can be associated with a delivery service provider.

The managing computing device(s) 204 can receive location data from the user computing device(s) 206. In some examples, the managing computing device(s) 204 can store the location data in the location analyzing component 230. In some examples, the location data can indicate the location of the user computing device(s) 206 associated with the user 208 or the pickup entity. In some examples, the location data can include Global Positioning System (GPS) data, sensor data, cellular location data (e.g., base station data or the like), indoor positioning data (e.g., WIFI beacon data, Bluetooth beacon data, or the like), mobile phone application data that share a user's location (e.g., a fitness app that monitors the user's steps and locations), and so on. In some examples, the location data can include latitude and longitude data associated with the user computing device(s) 206, accuracy data associated with the location data, speed data associated with the user computing device(s) 206, timestamp data associated with the location data or the like. In some examples, the location data can be updated periodically (e.g., every 0.5 seconds, every second, every 2 seconds, or the like), in real-time, in near real-time, on demand, any regular or irregular intervals, etc.

In some examples, the location analyzing component 230 can determine a distance between the location of the user computing device(s) 206 and the location of the store based on the location data and/or map data. In some examples, the location analyzing component 230 can determine whether the location associated with the user computing device(s) 206 is within a threshold distance to the store based on the location data and the map data.

The managing computing device(s) 204 can include a map data library 232 which may include map data. In some examples, the map data can include land boundary data of driving space (e.g., streets, freeways, highways, bridges, or the like), buildings (e.g., houses, hotels, hospitals, offices, churches, libraries, or the like), facilities (e.g., parking lots, gas stations, bus stops, rest areas, service areas, checkpoints, or the like), green spaces (e.g., lawns, bushes, trees, woods, gardens, or the like), waters (e.g., rivers, lakes, seas, or the like), and so on. In some examples, the map data can include, but is not limited to, imagery data, terrain data, latitude and longitude coordinates, transit data, traffic data, or the like.

The managing computing device(s) 204 can include an estimation component 234. In some examples, the managing computing device(s) 204 can be configured to determine an estimated arrival time (EAT) of the user 208 or the pickup entity at least based on the location data, the map data, or the like. In some examples, the estimated arrival time can be indicative of the time the customer will arrive at the store.

In some examples, the estimation component 234 can be configured to determine a preparation time for the order (or the batched order). In some examples, the preparation time can be determined based on the types of the order (e.g., food, drinks, snacks, or the like), the volume of the order (e.g., an individual order, a combo order, a catering order, or the like), the busyness of the store, etc. In some examples, the preparation time for the order can be provided by the store.

In some examples, the estimation component 234 can be configured to determine a starting time for an order (or a batched order) based on a current time, the estimated arrival time, the preparation time for the order (or the batched order), or the like. In some examples, the estimation component 234 can be configured to determine an estimated waiting time for the user 208 or the third party based on a current time, the starting time, the estimated arrival time, the preparation time for the order (or the batched order), or the like.

The managing computing device(s) 204 can include a GUI generating component 236 which is configured to generate GUI data to be displayed on a display. In some examples, the managing computing device(s) 204 may send the GUI data to be displayed to the store computing device(s) 202 via the network(s) 210. In some instances, the GUI data can include, location data of the user computing device(s) associated with the user 208 or a third party, user data associated with the user 208, order data associated with the user 208, timestamp data associated with the order data, estimated arrival time data associated with the user 208 or a third party, preparation time data associated with the order, order queue data, or the like.

In some examples, the managing computing device(s) 204 may send the GUI data to be displayed to the user computing device(s) 206 via the network(s) 210. In some examples, the GUI data to be displayed may include information indicating a state (e.g., processing, preparing, ready, or the like) of the order (or the batched order), location of the store, the estimated arrival time of the user 208 or the third party, the preparation time for the order (or the batched order) associated with the user 208, an estimated waiting time, and so on.

The managing computing device(s) 204 can include a message component 238 configured to communicate messages, alerts, reports, analytics, recommendations, instructions, data, etc. to the store computing device(s) 202 and the user computing device(s) 206 associated with the user 208 or the third party via the network(s) 210. As can be understood in the context of this disclosure, messages/alerts can take various forms, including but not limited to a text message, web-portal, email, website, push notification, pull notification, applications (“apps”), voice messages, graphical messages, video messages, or the like.

The user computing device(s) 206 can include one or more processor(s) 240, a memory 242, and a communication component 244, each of which can be implemented similarly to the processor(s) 212, the memory 214, and/or the communication component 244 of the store computing device(s) 202.

The user computing device(s) 206 can include an order component configured to receive order data and/or user data associated with the user 208. In some examples, the order data may indicate services and/or items ordered by the user (e.g., food items, drink items, prescription drugs, grocery items, or the like) and timestamps (which may indicate the time the order was made) associated with the order data.

In some examples, the user data may include name data, username data, address data, email address data, phone number data, date of birth data, age data, gender data, passwords data, security questions and answers data, preference data (which may indicate preferences associated with the user, e.g., sweet, sour, salty, bitter, savory preferences, or the like), food allergy data (which may indicate food allergies associated with the user, e.g., gluten allergy, peanut allergy, seafood allergy, or the like), discount data (which may indicate the discount information associated with the user, e.g., promo codes, coupons, credits, or the like), membership data (which may indicate membership information associated with the user), payment data (which may indicate payment information associated with the user, such as debit card information, credit card information, PayPal information, check information, or the like), history data (which may indicate historical orders made by the user), or the like.

In some examples, the user data may be input by the user 208 via the user computing device(s). Additionally or alternatively, the user computing device(s) 206 can receive the user data from a third-party platform (e.g., social media, a delivery service platform, a medical service platform, a customer database, a shopping website, a cloud database, or the like).

The user computing device(s) 206 can also include a location component 246 configured to collect location data associated with the user computing device(s) 206. In some examples, the location data can include Global Positioning System (GPS) data, sensor data, cellular location data (e.g., base station data or the like), indoor positioning data (e.g., WIFI beacon data, Bluetooth beacon data, or the like), mobile phone application data that share a user's location (e.g., a fitness app that monitors the user's steps and locations), and so on. In some examples, the location data can include a latitude associated with the user computing device 206, a longitude associated with the user computing device 206, an accuracy associated with location data, a speed associated with the user computing device, or timestamp data associated with the location data. In some examples, the location data can be updated in a predetermined period of time, in real-time, in near real-time, etc.

The user computing device(s) 206 can include a display component 248 to display graphical user interfaces on the user computing device(s) 206. In some examples, the user computing device(s) 206 can receive the GUI data to be displayed from the managing computing device(s) 204 via the network(s) 210. In some examples, the display component 248 may display information indicating a state of the order (e.g., processing, preparing, ready, or the like), the location of the store, the location of the user computing device(s) 206, estimated waiting time, messages/alerts, and so on.

The network(s) 210 can include the Internet, a Mobile Telephone Network (MTN), Wi-Fi, a cellular network, a mesh network, a Local Area Network (LAN), a Wide Area Network (WAN), a Virtual LAN (VLAN), a private network, and/or other various wired or wireless communication technologies.

Note that though FIG. 2 shows one user 208 and associated user computing device(s) 206, there can be multiple users and multiple user computing device(s) 206 in the environment 200.

The operations of the store computing device(s) 202, the managing computing devices(s) 204, and the user computing device(s) 206 are further provided in connection with the various figures of this disclosure. Further, any of the functions or operations provided by one component can be provided by any other component discussed herein. That is, features of the managing computing device(s) 204 can be provided by the store computing device(s) 202 and/or the user computing device(s) 206 (or the vehicle), and vice versa. For example, the store computing device(s) 202 can also have components to perform similar operations discussed with regard to managing computing device(s) 204. Further, there may be multiple devices (e.g., multiple computing devices 204) providing various functionality discussed herein.

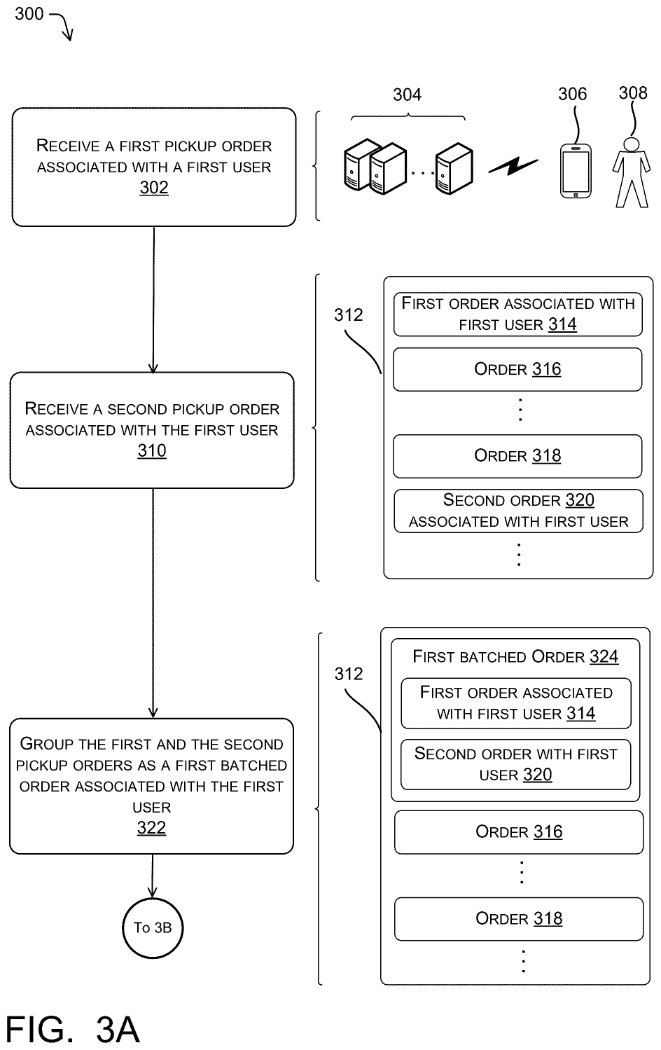

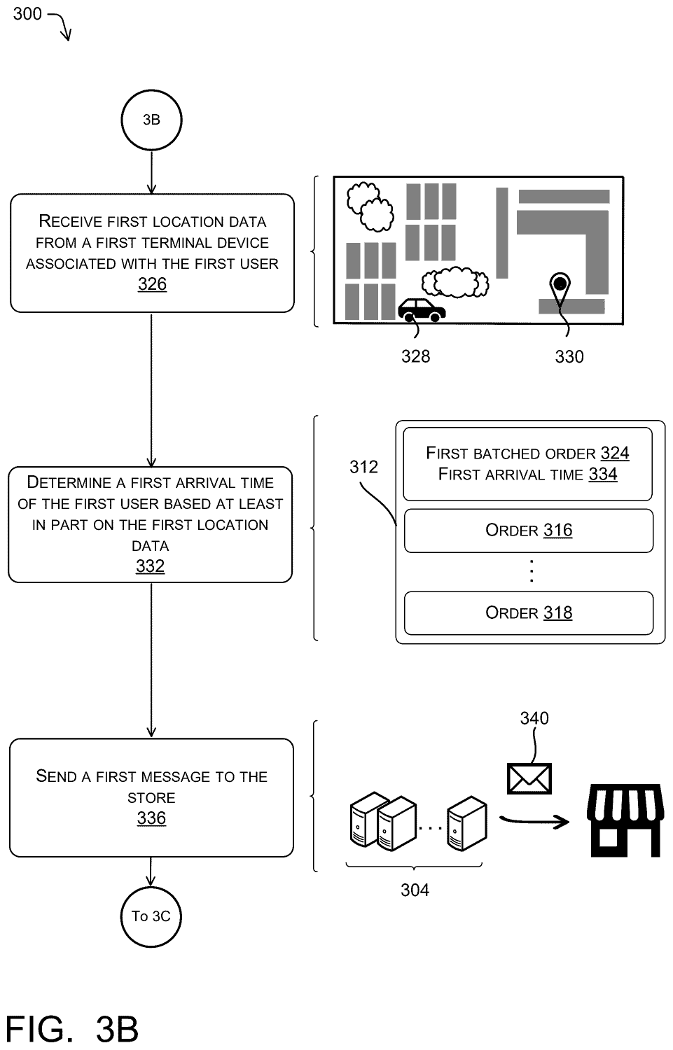

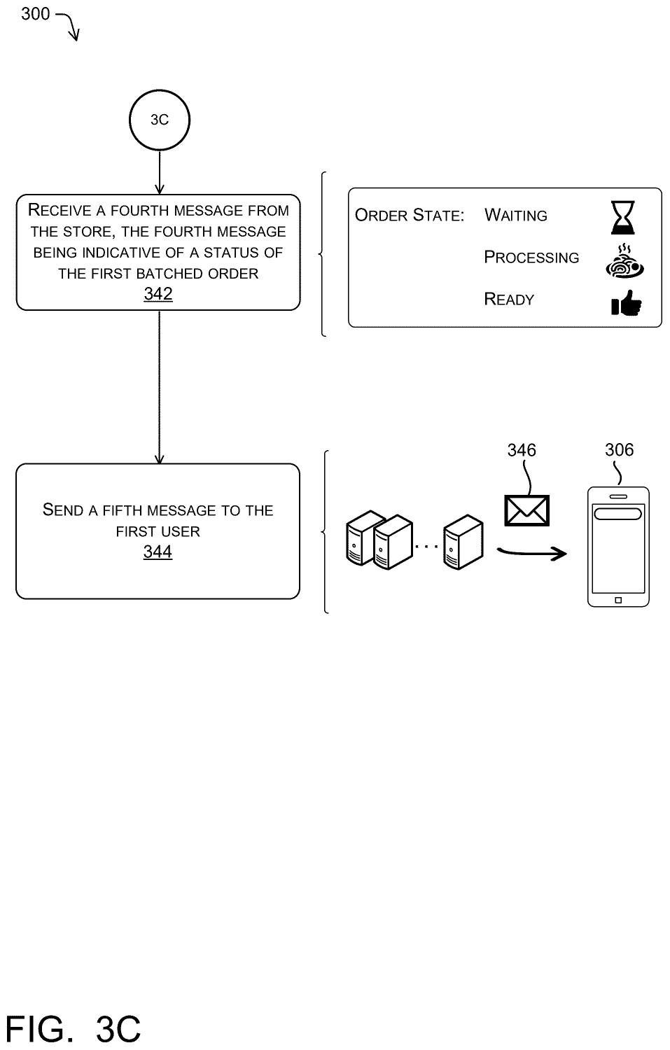

FIGS. 3A-3C illustrate an example process 300 for managing pickup orders in accordance with examples of the disclosure. In some examples, at least some operations of the process 300 may be performed by the managing computing device(s) 108 in FIG. 1 and the managing computing device(s) 204 in FIG. 2 as described herein.

Referring to FIG. 3A, at 302, operations may include receiving a first pickup order at a first time point associated with a first user 308. In some instances, the first pickup order may be directed to a store. In some examples, the store and/or managing computing device(s) 304 can receive the first order from the first user device(s) 306 associated with the first user 308. In some examples, the first order 314 may be associated with a first pickup entity (e.g., rather than a first user).

At operation 310, operations may include receiving a second pickup order at a second time point, whereby the second pickup order may be associated with the first user. In some examples, the second order 320 may be associated with the first pickup entity (e.g., and a second user, rather than the first user). In some instances, the second pickup order may be directed to the store. In some instances, the managing computing device(s) 304 can maintain an order queue 312 listing various orders, for example, the first order 314 is associated with the first user, an order 316, an order 318, the second order 320 associated with the first user. In some examples, the orders in the order queue can be sorted based on time stamps (which may indicate when the order is made) associated with the orders. In some examples, the orders in the order queue can be sorted based on EAT, the preparation time for the order, the starting time, or the like. Additional details of the order queue are given throughout this disclosure.

At operation 322, operations may include grouping the first and the second pickup orders as a first batched order 324 associated with the first user 308 (or first pickup entity). In some examples, the first batched order 324 can be determined based on information associated with the pickup entity, such as vehicle details (e.g., make, model, color, license information), pickup entity (e.g., driver) name, and the like. In some instances, the order queue 312 can be updated after the first and the second pickup orders are batched together. In some examples, the operation 322 can include receiving order data associated with the orders, which may include information associated with a pickup entity (e.g., indicative of a delivery service provider that may be picking up the first order and the second order).

In some examples, the first order can be associated with a first user and the second order can be associated with a second user, while the first order and the second order can be associated with the same delivery service provider (e.g., the same delivery service provider can be tasked with picking up and delivery the first order to the first user and the second order to the second user).

Referring to FIG. 3B, at operation 326, operations may include receiving first location data from the first user device associated with the first user 308. In some instances, the first location data may indicate a first location of the first user device or a first vehicle 328, a store location 330, a distance between the first location and the store location, speed associated with the user computing device, a timestamp associated with the first location, or the like.

At operation 332, operations may include determining a first arrival time 334 of the first user (and/or a pickup entity) based at least in part on the first location data. In some instances, the first arrival time may be indicative of when the first user will arrive at the store. In some instances, the first arrival time 334 can be associated with the first batched order 324 in the order queue 312.

At operation 336, operations may include sending a first message 340 to a store computing device associated with the store. In some instances, the first message 340 may be indicative of the arrival time and the first batched order associated with the first user.

Referring to FIG. 3C, at operation 342, operations may include receiving a fourth message from the store computing device associated with the store. In some instances, the fourth message may be indicative of an order state of the first batched order. For example, the order state can include a waiting state (indicating that the order has not been prepared), a processing state (indicating that the order is under preparation), a ready state (indicating that the order is ready), or the like. Note that these states are exemplary rather than limiting, and there can be other order states such as an error state, a canceled state, a delayed state, or the like.

At operation 344, operations may include sending a fifth message 346 to the first user device 306. the fifth message being indicative of the state of the first batched order. The fifth message 346 can take various forms, including but not limited to a text message, web-portal, email, website, push notification, pull notification, applications (“apps”), voice messages, graphical messages, video messages, or the like. In some instances, the fifth message 346 can be displayed via a GUI on the first user device 306.

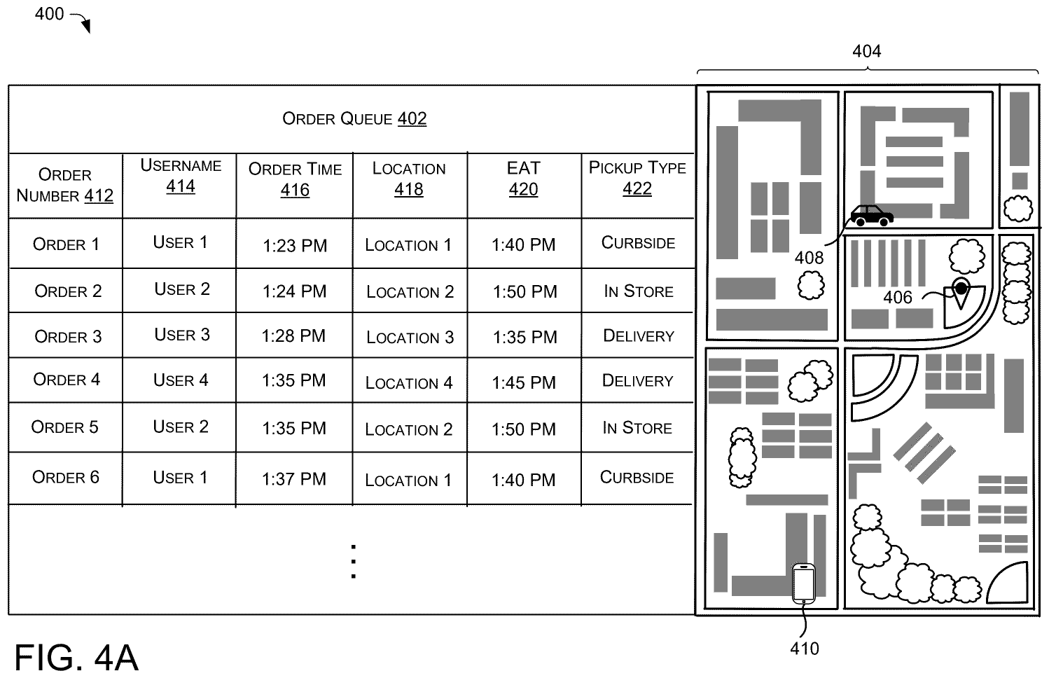

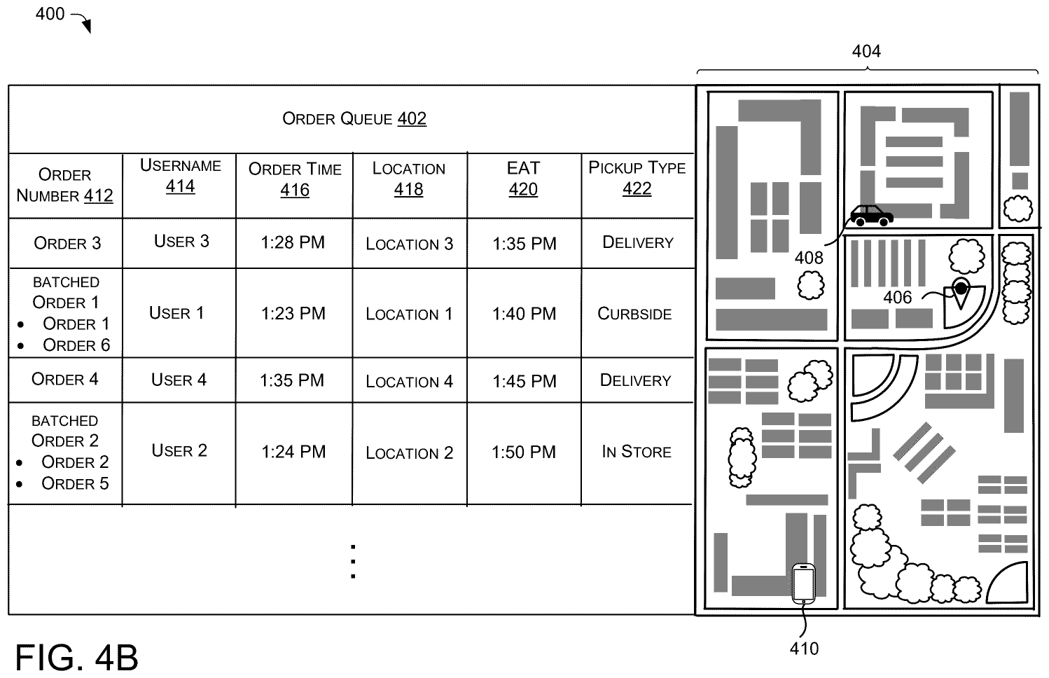

FIGS. 4A and 4B illustrate an example graphical user interface (GUI) 400 that can be displayed via a display component on a store computing device in accordance with examples of the disclosure. In various examples, the GUI 400 can be displayed on the store computing device(s) 114 in FIG. 1, the display component 220 of the store computing device(s) 202 in FIG. 2, the store computing device(s) 304 of the store in FIGS. 3A-3C, or the like. In some examples, the GUI 400 can be generated by the managing computing device(s) 108 in FIG. 1, the managing computing device(s) 204 in FIG. 2, and/or the managing computing device(s) 304 in FIGS. 3A-3C, or the like. Additionally or alternatively, the GUI 400 can be generated by the store computing device(s) 114 in FIG. 1, the store computing device(s) 202 in FIG. 2, and the store computing device(s) 304 of the store in FIGS. 3A-3C, or the like.

Referring to FIG. 4A, the GUI 400 can include an order queue 402 listing various orders directed to the store and/or a graph 404 presenting an environment including the store and one or more user computing devices (or vehicles).

The order queue 402 can present various descriptors of orders, including but are not limited to, order number 412 (indicating a unique number to identify the order), username 414, order time 416 (indicating the time the order is made), location 418 (indicating a current location of a user device associated with a pickup entity), EAT 420 (indicating an estimated arrival time of user 1 or the pickup entity), pickup type 422 (indicating a manner of pickup such as delivery, curbside pickup, in-store pickup, drive-through pickup, or the like). For example, the order queue 402 presents that user 1 made order 1 at 1:23 PM. The location associated with a first user device (or a first vehicle) associated with user 1 (or a pickup entity) is location 1. The EAT associated with the first user device (or the first vehicle) associated with user 1 (or a pickup entity) is 1:40 PM. The pickup type of order 1 can be curbside pickup.

In this example, the order queue 402 presents that user 2 made order 2 at 1:24 PM. The location associated with a second user device (or a second vehicle) associated with user 2 (or a pickup entity) is location 2. The EAT associated with the second user device (or the second vehicle) associated with user 2 (or a pickup entity) is 1:50 PM. The pickup type of order 2 can be in store pickup.

In this example, the order queue 402 presents that user 3 made order 3 at 1:28 PM. The location associated with a third user device (or a third vehicle) associated with user 3 (or a pickup entity) is location 3. The EAT associated with the third user device (or the third vehicle) associated with user 3 (or a pickup entity) is 1:35 PM. The pickup type of order 3 can be delivery.

In this example, the order queue 402 presents that user 4 made order 4 at 1:35 PM. The location associated with a fourth user device (or a fourth vehicle) associated with user 4 (or a pickup entity) is location 4. The EAT associated with the fourth user device (or the fourth vehicle) associated with user 4 (or a pickup entity) is 1:45 PM. The pickup type of order 4 can be delivery.

In this example, the order queue 402 presents that user 2 made order 5 at 1:35 PM. The location associated with a second user device (or a second vehicle) associated with user 2 (or a pickup entity) is location 2. The EAT associated with the second user device (or the second vehicle) associated with user 2 (or a pickup entity) is 1:50 PM. The pickup type of order 5 can be in store pickup.

In this example, the order queue 402 presents that user 1 made order 6 at 1:35 PM. The location associated with a first user device (or a first vehicle) associated with user 1 (or a pickup entity) is location 1. The EAT associated with the first user device (or the first vehicle) associated with user 1 (or a pickup entity) is 1:40 PM. The pickup type of order 6 can be curbside pickup.

The graph 404 can present an environment including the store location and the locations of the user devices (or vehicles) associated with various users (or pickup entities). For example, the graph 404 shows a store location 406, a first location of the first vehicle 408, and a second location of the second user device 410. Additionally, the graph 404 can present other features such as a route of the user device (or vehicle), the speed of the user device (or vehicle), the EAT associated with the user device (or vehicle), a distance between the location of the user device (or vehicle) and the store location, or the like. In some examples, graphs 404 can be updated in a predetermined period of time, in real-time, in near real-time, etc.

Referring to FIG. 4B, the order queue 402 can be updated in the following manner. For example, orders associated with the same user (or same pickup entity) can be batched as a batched order. The orders can be list based on EAT. In this example, the order queue 402 presents that order 3 is made by user 3 at 1:28 PM. The location associated with a third user device (or a third vehicle) associated with user 3 (or a pickup entity) is location 3. The EAT associated with the third user device (or the third vehicle) associated with user 3 (or a pickup entity) is 1:35 PM. The pickup type of order 3 can be delivery.

In this example, because order 1 and order 6 are both made by user 1, these orders can be batched to be batched order 1. The order queue 402 presents that batched order 1 is made by user 1 at 1:23 PM (an earlier time of the order 1 and order 6). The location associated with a first user device (or a first vehicle) associated with user 1 (or a pickup entity) is location 1. The EAT associated with the first user device (or the first vehicle) associated with user 1 (or a pickup entity) is 1:40 PM. The pickup type of batched order 1 can be curbside pickup.

In this example, the order queue 402 presents that order 4 is made by user 4 at 1:35 PM. The location associated with a fourth user device (or a fourth vehicle) associated with user 4 (or a pickup entity) is location 4. The EAT associated with the fourth user device (or the fourth vehicle) associated with user 4 (or a pickup entity) is 1:45 PM. The pickup type of order 4 can be delivery.

In this example, because order 2 and order 5 are both made by user 2, these orders can be batched to be batched order 2. The order queue 402 presents that batched order 2 is made by user 2 at 1:24 PM (an earlier time of the order 2 and order 5). The location associated with a second user device (or a second vehicle) associated with user 2 (or a pickup entity) is location 2. The EAT associated with the second user device (or the second vehicle) associated with user 2 (or a pickup entity) is 1:50 PM. The pickup type of batched order 2 can be in store pickup.

In the order queue 402 depicted in FIG. 4A and 4B, an individual order or a batched order can be associated with a priority. The orders can be sorted based on priorities associated with the orders. In some examples, when a new order is received, the new order can be inserted into the order queue based on the priority associated with the new order. As described herein, the priority of an individual order (or a batched order) can be determined based on the EAT, the preparation time for the order (or the batched order), the starting time, or the like. Additional details regarding how to determine priorities of orders are given throughout this disclosure.

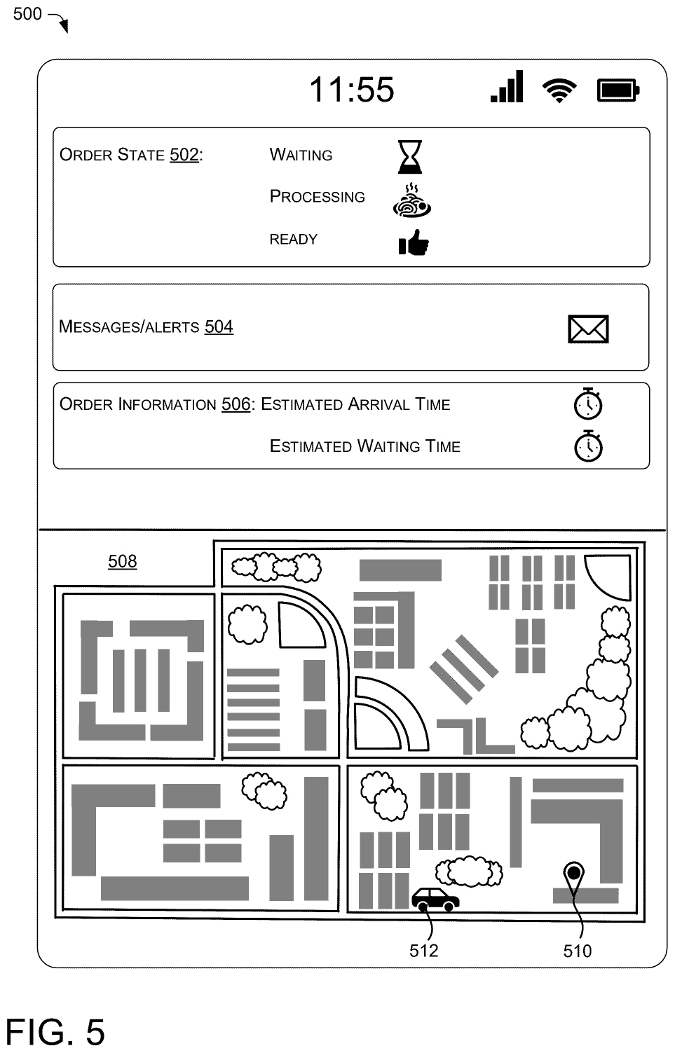

FIG. 5 illustrates an example GUI 500 that can be displayed on a display of a user device in accordance with examples of the disclosure. In various examples, GUI 500 can be displayed on the first user device(s) 110 and the second user device(s) 112 in FIG. 1, the user computing device 206 in FIG. 2, the user computing device(s) 306 in FIGS. 3A-3C.

The GUI 500 can include an element illustrating an order state 302 indicating various states of the order (or the batched order), such as a waiting state (indicating that the order has not been prepared), a processing state (indicating that the order is under preparation), and a ready state (indicating that the order is ready for pickup). Note that the GUI 500 can include other order states such as an error state, a canceled state, a delayed state, and so on.

The GUI 500 can include an element illustrating messages/alerts 504. As can be understood in the context of this disclosure, messages/alerts 504 can take many forms, including but not limited to a text message, a web-portal, an email, a web page, a push notification, a pull notification, a popup window, specific applications (“apps”), a voice message, a video message, or the like.

The GUI 500 can include an element illustrating order information 506 associated with the order (or the batched order) such as an EAT, an estimated waiting time, or the like.

The GUI 500 can illustrate a graph 508 reflecting the location 510 of the store and the location 512 associated with the user computing device (or the user vehicle). In some examples, the graph 508 can be generated based on the location data, the map data, or the like. Additional details of the location data are given throughout this disclosure. Additionally, the graph 508 can present other features such as a route of the user device (or vehicle), the speed of the user device (or vehicle), the EAT associated with the user device (or vehicle), a distance between the location of the user device (or vehicle) and the store location, or the like. In some examples, graphs 508 can be updated in a predetermined period of time, in real-time, in near real-time, etc.

While illustrative examples have been illustrated and described, it will be appreciated that various changes can be made therein without departing from the spirit and scope of the present disclosure.

### EXAMPLE CLAUSES

A: A system comprising: one or more processors; and one or more non-transitory computer-readable media storing instructions executable by the one or more processors, wherein the instructions, when executed, cause the system to perform operations comprising: receiving a first pickup order made at a first time point associated with a first pickup entity, the first pickup order being directed to a store; receiving a second pickup order made at a second time point associated with the first pickup entity, the second pickup order being directed to the store; determining, based on pickup entity information associated with the first pickup entity, that the first pickup order and the second pickup orders are to be grouped together as a first batched order; receiving first location data from a first computing device associated with the first pickup entity; determining a first estimated arrival time of the first pickup entity based at least in part on the first location data, the first estimated arrival time being indicative of when the first pickup entity will arrive at the store; and sending a first message to a store computing device associated with the store, the first message being indicative of the first estimated arrival time and the first batched order associated with the first pickup entity.

B: The system of paragraph A, wherein: receiving a third pickup order made at a third time point associated with a second user, the third pickup order being directed to the store; receiving a fourth pickup order made at a fourth time point associated with the second user, the fourth pickup order being directed to the store; grouping the third and the fourth pickup orders as a second batched order associated with the second user; receiving second location data from a second computing device associated with the second user; determining a second estimated arrival time of the second user based at least in part on the second location data, the second estimated arrival time being indicative of when the second user will arrive at the store; determining that the second estimated arrival time is earlier than the first estimated arrival time; and sending a second message to the store computing device associated with the store, the second message being indicative of the second batched order associated with the second user, the second estimated arrival time, and that the second estimated arrival time is earlier than the first estimated arrival time.

C: The system of paragraph B, the operations further comprising: generating an order queue, the order queue listing the first batched order and the second batched order based at least in part on the first estimated arrival time and the second estimated arrival time; and sending a third message to the store computing device associated with the store, the third message including the order queue.

D: The system of paragraph C, the operations further comprising: determining a first preparation time for the first batched order; determining a first starting time based at least in part on the first estimated arrival time and the first preparation time for the first batched order; determining a second preparation time for the second batched order; determining a second starting time based at least in part on the second estimated arrival time and the second preparation time for the second batched order; and updating the order queue based at least in part on the first starting time and the second starting time.

E: The system of any of paragraphs A-D, wherein the first pickup entity comprises at least one of a pickup service provider, a deliverer, or a non-human entity.

F: A method for managing multiple pickup orders, the method comprising: receiving a first pickup order associated with a first user, the first pickup order being directed to a store; receiving a second pickup order associated with the first user, the second pickup order being directed to the store; grouping the first pickup order and the second pickup order as a first batched order associated with the first user; and sending a first message to a store computing device associated with the store, the first message being indicative of the first batched order associated with the first user.

G: The method of paragraph F, wherein the first user is associated with at least one of a username, a phone number, an email address, an address, an order identifier, or a transaction identifier.

H: The method of paragraph For G, further comprising: receiving first location data from a first computing device associated with the first user; and determining a first estimated arrival time of the first user or a third party based at least in part on the first location data, the first estimated arrival time being indicative of when the first user or the third party will arrive at the store; wherein the first message is further indicative of the first estimated arrival time.

I: The method of paragraph H, wherein: receiving a third pickup order made at a third time point associated with a second user, the third pickup order being directed to the store; receiving a fourth pickup order made at a fourth time point associated with the second user, the fourth pickup order being directed to the store; grouping the third and the fourth pickup orders as a second batched order associated with the second user; receiving second location data from a second computing device associated with the second user; determining a second estimated arrival time of the second user based at least in part on the second location data, the second estimated arrival time being indicative of when the second user will arrive at the store; determining that the second estimated arrival time is earlier than the first estimated arrival time; and sending a second message to the store computing device associated with the store, the second message being indicative of the second batched order associated with the second user, the second estimated arrival time, and that the second estimated arrival time is earlier than the first estimated arrival time.

J: The method of paragraph I, further comprising: generating an order queue, the order queue listing the first batched order and the second batched order based at least in part on the first estimated arrival time and the second estimated arrival time; and sending a third message to the store computing device associated with the store, the third message including the order queue.

K: The method of paragraph J, further comprising: determining a first preparation time for the first batched order; determining a first starting time based at least in part on the first estimated arrival time and the first preparation time for the first batched order; determining a second preparation time for the second batched order; determining a second starting time based at least in part on the second estimated arrival time and the second preparation time for the second batched order; and updating the order queue based at least in part on the first starting time and the second starting time.

L: The method of any of paragraphs H-K, wherein the third party comprises at least one of a pickup service provider, a deliverer, or a non-human entity.

M: The method of any of paragraphs F-L, further comprising: receiving a fourth message from the store computing device associated with the store, the fourth message being indicative of a state of the first batched order; and sending a fifth message to a first user device, the fifth message being indicative of the state of the first batched order.

N: The method of paragraph M, wherein the state comprises at least one of a ready state, a processing state, or a waiting state.

O: One or more non-transitory computer-readable media storing processor-executable instructions that, when executed by one or more processors, cause the one or more processors to perform operations comprising: receiving a first pickup order associated with a first user, the first pickup order being directed to a store; receiving a second pickup order associated with the first user, the second pickup order being directed to the store; grouping the first pickup order and the second pickup order as a first batched order associated with the first user; and sending a first message to a store computing device associated with the store, the first message being indicative of the first batched order associated with the first user.

P: The one or more non-transitory computer-readable media of paragraph O, wherein the first user is associated with at least one of a username, a phone number, an email address, or an address.

Q: The one or more non-transitory computer-readable media of paragraph O or P, the operations further comprising: receiving first location data from a first computing device associated with the first user; and determining a first estimated arrival time of the first user or a third party based at least in part on the first location data, the first estimated arrival time being indicative of when the first user or the third party will arrive at the store; wherein the first message is further indicative of the first estimated arrival time.

R: The one or more non-transitory computer-readable media of paragraph Q, wherein: receiving a third pickup order made at a third time point associated with a second user, the third pickup order being directed to the store; receiving a fourth pickup order made at a fourth time point associated with the second user, the fourth pickup order being directed to the store; grouping the third and the fourth pickup orders as a second batched order associated with the second user; receiving second location data from a second computing device associated with the second user; determining a second estimated arrival time of the second user based at least in part on the second location data, the second estimated arrival time being indicative of when the second user will arrive at the store; determining that the second estimated arrival time is earlier than the first estimated arrival time; and sending a second message to the store computing device associated with the store, the second message being indicative of the second batched order associated with the second user, the second estimated arrival time, and that the second estimated arrival time is earlier than the first estimated arrival time.

S: The one or more non-transitory computer-readable media of paragraph R, the operations further comprising: generating an order queue, the order queue listing the first batched order and the second batched order based at least in part on the first estimated arrival time and the second estimated arrival time; and sending a third message to the store computing device associated with the store, the third message including the order queue.

T: The one or more non-transitory computer-readable media of paragraph S, the operations further comprising: determining a first preparation time for the first batched order; determining a first starting time based at least in part on the first estimated arrival time and the first preparation time for the first batched order; determining a second preparation time for the second batched order; determining a second starting time based at least in part on the second estimated arrival time and the second preparation time for the second batched order; and updating the order queue based at least in part on the first starting time and the second starting time.

U: A method comprising: receiving map data representing an environment proximate a store; receiving order data indicative of order information associated with the store; receiving store data indicative of a staffing level associated with the store; inputting the map data, the order data, and the store data into a machine learning model; and receiving, from the machine learning model and based on the map data, the order data, and the store data, capacity data associated with the store indicative of a number of orders that the store can output meeting a threshold period of time, and attribute information associated with the number of orders.

V: The method of paragraph U, wherein the order data comprises historical order data associated with the store.

W: The method of paragraph U or V, wherein the store data comprises a number of staff on duty associated with a particular time period and staff attribute data associated with individual ones of the staff on duty.

X: The method of any of paragraphs U-W, wherein the capacity data indicates that the number of orders that can be satisfied by the store, wherein an order satisfied by the store is one in which the order can be ready for pickup or delivery within a threshold period of time.

Y: The method of paragraph X, wherein the threshold period of time is output by the machine learning model at least partially in response to at least one of the map data, the order data, or the store data.

Z: The method of any of paragraphs U-Y, further comprising: receiving additional data comprising at least one of picking solution data, kitchen display system data, fulfillment data, staffing data, inventory data, or reservation data; and inputting the additional data into the machine learning model; wherein receiving the capacity data and the attribute information is further based at least in part on the additional data.

While the example clauses described above are described with respect to one particular implementation, it should be understood that, in the context of this document, the content of the example clauses can also be implemented via a method, device, system, computer-readable medium, and/or another implementation. Additionally, any of examples A-Z may be implemented alone or in combination with any other one or more of the examples A-Z.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be implemented in, and fully automated via, software code components and/or computer-executable instructions executed by one or more computers or processors, hardware, or some combination thereof. Some or all of the methods may alternatively be implemented in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements, and/or steps are in any way required for one or more examples or that one or more examples necessarily include logic for deciding, with or without user input or prompting, whether certain features, elements and/or steps are included or are to be performed in any designated example.

Conjunctive languages such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements, or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing instructions executable by the one or more processors, wherein the instructions, when executed, cause the system to perform operations comprising:
receiving a first pickup order made at a first time point associated with a first pickup entity, the first pickup order being directed to a store;
receiving a second pickup order made at a second time point associated with the first pickup entity, the second pickup order being directed to the store;
determining, based on pickup entity information associated with the first pickup entity, that the first pickup order and the second pickup order are to be grouped together as a first batched order;
receiving first location data from a first computing device associated with the first pickup entity;
determining a first estimated arrival time of the first pickup entity based at least in part on the first location data, the first estimated arrival time being indicative of when the first pickup entity will arrive at the store; and
sending a first message to a store computing device associated with the store, the first message being indicative of the first estimated arrival time and the first batched order associated with the first pickup entity.

2. The system of claim 1, wherein:
receiving a third pickup order made at a third time point associated with a second user, the third pickup order being directed to the store;
receiving a fourth pickup order made at a fourth time point associated with the second user, the fourth pickup order being directed to the store;
grouping the third pickup order and the fourth pickup order as a second batched order associated with the second user;
receiving second location data from a second computing device associated with the second user;
determining a second estimated arrival time of the second user based at least in part on the second location data, the second estimated arrival time being indicative of when the second user will arrive at the store;
determining that the second estimated arrival time is earlier than the first estimated arrival time; and
sending a second message to the store computing device associated with the store, the second message being indicative of the second batched order associated with the second user, the second estimated arrival time, and that the second estimated arrival time is earlier than the first estimated arrival time.

3. The system of claim 2, the operations further comprising:
generating an order queue, the order queue listing the first batched order and the second batched order based at least in part on the first estimated arrival time and the second estimated arrival time; and
sending a third message to the store computing device associated with the store, the third message including the order queue.

4. The system of claim 3, the operations further comprising:
determining a first preparation time for the first batched order;
determining a first starting time based at least in part on the first estimated arrival time and the first preparation time for the first batched order;
determining a second preparation time for the second batched order;
determining a second starting time based at least in part on the second estimated arrival time and the second preparation time for the second batched order; and
updating the order queue based at least in part on the first starting time and the second starting time.

5. The system of claim 1, wherein the first pickup entity comprises at least one of a pickup service provider, a deliverer, or a non-human entity.

6. A method for managing multiple pickup orders, the method comprising:
receiving a first pickup order associated with a first user, the first pickup order being directed to a store;
receiving a second pickup order associated with the first user, the second pickup order being directed to the store;
grouping the first pickup order and the second pickup order as a first batched order associated with the first user; and
sending a first message to a store computing device associated with the store, the first message being indicative of the first batched order associated with the first user.

7. The method of claim 6, wherein the first user is associated with at least one of a username, a phone number, an email address, an address, an order identifier, or a transaction identifier.

8. The method of claim 6, further comprising:
receiving first location data from a first computing device associated with the first user; and
determining a first estimated arrival time of the first user or a third party based at least in part on the first location data, the first estimated arrival time being indicative of when the first user or the third party will arrive at the store;
wherein the first message is further indicative of the first estimated arrival time.

9. The method of claim 8, wherein:
receiving a third pickup order made at a third time point associated with a second user, the third pickup order being directed to the store;
receiving a fourth pickup order made at a fourth time point associated with the second user, the fourth pickup order being directed to the store;
grouping the third pickup order and the fourth pickup order as a second batched order associated with the second user;
receiving second location data from a second computing device associated with the second user;
determining a second estimated arrival time of the second user based at least in part on the second location data, the second estimated arrival time being indicative of when the second user will arrive at the store;
determining that the second estimated arrival time is earlier than the first estimated arrival time; and
sending a second message to the store computing device associated with the store, the second message being indicative of the second batched order associated with the second user, the second estimated arrival time, and that the second estimated arrival time is earlier than the first estimated arrival time.

10. The method of claim 9, further comprising:
generating an order queue, the order queue listing the first batched order and the second batched order based at least in part on the first estimated arrival time and the second estimated arrival time; and
sending a third message to the store computing device associated with the store, the third message including the order queue.

11. The method of claim 10, further comprising:
determining a first preparation time for the first batched order;
determining a first starting time based at least in part on the first estimated arrival time and the first preparation time for the first batched order;
determining a second preparation time for the second batched order;
determining a second starting time based at least in part on the second estimated arrival time and the second preparation time for the second batched order; and
updating the order queue based at least in part on the first starting time and the second starting time.

12. The method of claim 8, wherein the third party comprises at least one of a pickup service provider, a deliverer, or a non-human entity.

13. The method of claim 6, further comprising:
receiving a fourth message from the store computing device associated with the store, the fourth message being indicative of a state of the first batched order; and
sending a fifth message to a first user device, the fifth message being indicative of the state of the first batched order.

14. The method of claim 13, wherein the state comprises at least one of a ready state, a processing state, or a waiting state.

15. One or more non-transitory computer-readable media storing processor-executable instructions that, when executed by one or more processors, cause the one or more processors to perform operations comprising:
receiving a first pickup order associated with a first user, the first pickup order being directed to a store;
receiving a second pickup order associated with the first user, the second pickup order being directed to the store;
grouping the first pickup order and the second pickup order as a first batched order associated with the first user; and
sending a first message to a store computing device associated with the store, the first message being indicative of the first batched order associated with the first user.

16. The one or more non-transitory computer-readable media of claim 15, wherein the first user is associated with at least one of a username, a phone number, an email address, or an address.

17. The one or more non-transitory computer-readable media of claim 15, the operations further comprising:
receiving first location data from a first computing device associated with the first user; and
determining a first estimated arrival time of the first user or a third party based at least in part on the first location data, the first estimated arrival time being indicative of when the first user or the third party will arrive at the store;
wherein the first message is further indicative of the first estimated arrival time.

18. The one or more non-transitory computer-readable media of claim 17, wherein:
receiving a third pickup order made at a third time point associated with a second user, the third pickup order being directed to the store;
receiving a fourth pickup order made at a fourth time point associated with the second user, the fourth pickup order being directed to the store;
grouping the third pickup order and the fourth pickup order as a second batched order associated with the second user;
receiving second location data from a second computing device associated with the second user;
determining a second estimated arrival time of the second user based at least in part on the second location data, the second estimated arrival time being indicative of when the second user will arrive at the store;
determining that the second estimated arrival time is earlier than the first estimated arrival time; and
sending a second message to the store computing device associated with the store, the second message being indicative of the second batched order associated with the second user, the second estimated arrival time, and that the second estimated arrival time is earlier than the first estimated arrival time.

19. The one or more non-transitory computer-readable media of claim 18, the operations further comprising:
generating an order queue, the order queue listing the first batched order and the second batched order based at least in part on the first estimated arrival time and the second estimated arrival time; and
sending a third message to the store computing device associated with the store, the third message including the order queue.

20. The one or more non-transitory computer-readable media of claim 19, the operations further comprising:
determining a first preparation time for the first batched order;
determining a first starting time based at least in part on the first estimated arrival time and the first preparation time for the first batched order;
determining a second preparation time for the second batched order;
determining a second starting time based at least in part on the second estimated arrival time and the second preparation time for the second batched order; and
updating the order queue based at least in part on the first starting time and the second starting time.
